(19) United States
(12) Patent Application Publication
(10) Pub. No.: US 2016/0236658 A1
(43) Pub. Date: Aug. 18, 2016

(54) DISC FOR DISC BRAKES AND BRAKING SYSTEM COMPRISING SUCH DISC

(71) Applicant: BREMBO SGL CARBON CERAMIC BRAKES S.P.A., Stezzano (bg) (IT)

(72) Inventor: Furio ROZZA, Stezzano (IT)

(21) Appl. No.: 15/022,867

(22) PCT Filed: Sep. 16, 2014
(86) PCT No.: PCT/IB2014/064560

§ 371 Date: Mar. 17, 2016

(30) Foreign Application Priority Data
Sep. 17, 2013 (IT) MI2013A001531

(51) Int. Cl. B60T 1/10; F16D 65/12

(52) U.S. Cl. CPC B60T 1/10; F16D 65/128; F16D 65/126; F16D 2065/1328

(57) ABSTRACT

A disc for a disc brake of a vehicle, the disc including: a drum and a radially external band that is extended around a symmetry axis (X-X), said radially external band having side braking surfaces adapted to cooperate with brake calipers in order to exert a braking action on a vehicle; and rotor elements of a rotary electrical machine adapted to cooperate with stator elements of said rotary electrical machine mounted on the vehicle.

### FIELD OF THE ART

The object of the present invention is a disc for disc brakes and a braking system comprising such disc. The invention refers in particular to disc brakes provided with a braking band, made of composite material comprising a carbon matrix or metal material (e.g. iron-carbon alloy), used in order to exert a braking action on vehicles. More particularly but not exclusively, the present invention refers to discs made of carbon and to discs made of carbon-ceramic. A disc brake comprises a drum and a radially external band that is extended around a symmetry axis and has side braking surfaces adapted to cooperate with brake calipers of the vehicle in order to exert a braking action on the vehicle itself. In a disc brake of composite type, the radially external band comprises a carbon matrix.

### STATE OF THE ART

Known today are energy recovery systems used on racecars (e.g. the kinetic energy recovery system “KERS” in Formula 1) and on road vehicles with the purpose of transforming the mechanical energy that is dissipated during braking into electrical energy for supplying power, for example, to on-board instruments and/or for supplying power to an electric motor connected to the drive wheels in order to have a power reserve that can be used in times of need.

### OBJECT OF THE INVENTION

In the scope of energy transformation devices (from electrical to mechanical and vice versa) mounted on vehicles, like that described above, the Applicant has observed that said devices are bulky and heavy and it is necessary to provide for—already during design—the space necessary on board the vehicle where they can be housed.

The Applicant has therefore set the objective of at least partly integrating a device for transforming energy (i.e. an electrical machine) in pre-existing vehicle elements (which per se accomplish other tasks), in order to limit the size and weight of the abovementioned device and possibly also allow the direct interaction thereof with said elements of the vehicle.

### SUMMARY OF THE INVENTION

The Applicant has found that such objective can be obtained by integrating parts of an electrical machine into the braking system. In particular, The Applicant has found that such objective can be obtained by mounting on a disc, in composite material or in metal material (e.g. iron-carbon alloy), of a disc brake, the rotor elements of a rotary electrical machine while the other elements of the electrical machine, including the stator elements, are integral with the vehicle.

The above-indicated objective is substantially reached by a disc for disc brakes and by a braking system according to one or more of the enclosed claims. Aspects of the invention are described hereinbelow.

More specifically, according to one aspect, the present invention regards a disc for disc brakes, comprising a drum and a radially external band that is extended around a symmetry axis, said radially external band having side braking surfaces adapted to cooperate with brake calipers in order to exert a braking action on a vehicle;

characterized in that it comprises rotor elements of a rotary electrical machine adapted to cooperate with stator elements of said rotary electrical machine mounted on the vehicle.

According to a different aspect, the present invention regards a braking system, comprising: a disc comprising at least the above-defined characteristics; a brake caliper arranged astride the disc; a rotary electrical machine comprising the rotor elements of the disc and stator elements mounted on the vehicle.

By “rotary electrical machine” it is intended in the present description and in the enclosed claims a device adapted to convert electrical energy into mechanical energy and/or mechanical energy into electrical energy, i.e. a motor or a generator, by exploiting the electromagnetic induction.

The Applicant has first of all verified that, given that it is partially integrated in the disc of the braking system, the electrical machine according to the invention is more compact and lighter than the energy transformation devices of known type installed on vehicles.

The Applicant has also verified that the invention ensures a direct interaction of the electrical machine with the wheels of the vehicle, as will be detailed hereinbelow, without the interposition of other transmission elements that would involve negative energy dissipations.

The Applicant has also verified that the quantity of energy that can be recovered with the disc and the system in accordance with the present invention is comparable at least to the quantity of energy recoverable with the known systems, such as “KERS”.

The present invention, in at least one of the aforesaid aspects, can have one or more of the preferred characteristics described hereinbelow.

Preferably, the rotor elements are integrated in the brake disc.

Preferably, the rotor elements are associated with the radially external band.

In a different embodiment said radially external band is made of metal material, preferably of iron, more preferably iron-carbon alloy, more preferably cast iron.

In one embodiment, said radially external band is made of composite material comprising carbon fibers.

The Applicant has verified that such placement of the rotor elements is effective due to the fact that the composite material of the radially external band of the disc (made of carbon and/or carbon-ceramic) has a magnetic permeability “μ” sufficiently high to ensure a correct distribution of the magnetic fields between the rotor elements and the stator elements and hence the correct operation of the electrical machine, better than that allowed by the conventional metal discs.

Preferably, the radially external band comprises a ceramic matrix, preferably made of silicon carbide, reinforced with carbon fibers.

Preferably, the radially external band comprises a matrix of carbon fiber, preferably made of fabric, reinforced with carbon fibers.

Preferably, the radially external band comprises protective layers, preferably ceramic, on both the braking surfaces.

Preferably, the rotor elements are embedded in the composite material. More preferably, the embedding is executed during the production of composite discs. In one embodiment, the radially external band is obtained by subjecting to heat and pressure resin powders and carbon fibers inserted in a mold in which, for example, the magnetic elements are also inserted in said mold. In a different embodiment, the radially external band is made by suitably coupling and/or shaping pieces and/or strips of fabric made of carbon fiber and subjecting the semifinished product to heat and pressure in which, for example, the magnetic elements are inserted between said pieces/strips, for example in sheet form.

Preferably, the rotor elements are inserted in housings made in the composite material. More preferably, the rotor elements are associated with the disc once the disc (obtained for example with the above-described methods) is substantially finished and shaped in a manner so as to present said housings.

Preferably, the rotor elements are covered by a protective layer, preferably ceramic, adapted to come into contact with pads of the brake caliper. In this manner, the direct contact between the pads and the rotor elements is avoided, even if the latter lie at the braking surfaces.

Preferably, the rotor elements are situated at a radially peripheral edge of the disc. Preferably, the rotor elements are situated in a radially more internal position with respect to the braking surfaces. In such position, the rotor elements, whether they are embedded and covered by the composite material or uncovered and, for example, flush with the same, do not interfere with the pads of the brake caliper which act in contact with the braking surfaces.

Preferably, the disc has ventilation channels and the rotor elements are positioned in said ventilation channels. The ventilation channels are delimited inside the radially external band between the two braking surfaces, preferably have a substantially radial extension and the rotor elements occupy, preferably in part, said channels.

The rotor elements can be induced or inductors according to the structure of the rotary electrical machine. Analogously the stator elements can be inductors or induced.

In one embodiment, the rotor elements are induced windings.

In one embodiment, the rotor elements comprise inductor electromagnets with magnetizing coils.

In one embodiment, the rotor elements are inductor permanent magnets.

Preferably, the rotor elements (the permanent magnets or the windings) define a ring coaxial with the symmetry axis of the disc. Such geometry ensures a uniform mass distribution around the rotation axis of the disc in a manner so as to prevent the onset of irritating vibrations.

Preferably, the rotor elements are arranged in succession around the symmetry axis of the disc to define a periodic ferromagnetic structure with parts made of conductor material interposed with each other. Preferably, if the disc is made of iron-carbon alloy and the rotor elements are situated in the ventilation channels, the conductor material parts are constituted by the walls of said channels. Preferably, if the disc is made of composite material, the conductor material parts are also embedded in the composite material and inserted between said rotor elements.

In one embodiment, if the structure of the rotary electrical machine requires it, ring collectors can be provided which slide on the rotor elements in order to conduct the current from said rotor elements to the vehicle or vice versa.

The stator elements can for example be induced windings, inductor electromagnets with magnetized windings, inductor permanent magnets.

Preferably, the rotary electrical machine is an asynchronous axial machine or an asynchronous radial machine or a synchronous reluctance machine or an axial/radial hybrid machine.

In one embodiment, the stator elements are integrated into the brake caliper.

In one embodiment, an auxiliary body is provided that is fixed with respect to the brake caliper, juxtaposed with the disc and comprising the stator elements. In this case, the auxiliary body is dedicated to carrying the stator elements.

Preferably, the auxiliary body is extended for a circular sector.

Preferably, the auxiliary body is extended over the entire circumferential extension of the disc.

Preferably, the auxiliary body is extended like a ring around a radially peripheral edge of the disc along the circumferential extension of said disc. Preferably, the auxiliary body is connected to the caliper and is extended like a partial ring around a radially peripheral edge of the disc, except where said caliper is present.

Preferably, the auxiliary body is placed astride the radially peripheral edge of the disc. In other words, in a section on a radial plane, the auxiliary body has a U shape. Preferably, the stator elements carried by the auxiliary body are extended astride the disc and the rotor elements carried by the disc are axially interposed between the ends of the U. Such is the geometric structure of an asynchronous axial machine or of an axial/radial hybrid machine. The asynchronous axial machine is distinguished for an advantageous and easy winding of the stator elements, for a good current intensity output per turn and for a good passage of cooling air (given that the rotor-stator vicinity is not necessary).

In a different embodiment, the auxiliary body is only placed in radially external position with respect to the radially peripheral edge of the disc. Preferably, the auxiliary body is axially extended for the thickness of the disc. Preferably, the stator elements are only situated in radially external position with respect to the rotor elements.

In one embodiment, the stator elements are only situated in radially internal position with respect to the rotor elements, for example in an auxiliary body placed at the hub of the wheel.

Such is the geometric structure of an asynchronous radial machine or of a synchronous reluctance machine.

The asynchronous radial machine comprises rotor elements and stator elements obtained from specific windings. The synchronous reluctance machine comprises rotor elements defined by permanent magnets and stator elements obtained from specific windings.

Both such machines are distinguished for the compactness of the assembly, also since the air interspace between the stator and the rotor must be limited to the minimum, and for the distance of the stator elements from the hottest zone of the disc, such that the heat produced by the break via friction has little effect on the machine performances. In addition, the synchronous reluctance machine has a structure, in particular that of the rotor disc, that is very simple.

Preferably, the auxiliary body has a placement similar to that of the brake caliper and, preferably, also an external shape similar to that of said brake caliper.

In one embodiment, the auxiliary body and the brake caliper form a single body distributed around the disc.

In one embodiment, the stator elements are integrated both in the brake caliper and situated in the auxiliary body.

Preferably, the auxiliary body is positioned on the side opposite a connection of the disc to a wheel and facing the disc.

Preferably, the auxiliary body is fit on the fixed tubular body which carries the shaft of the wheel.

In this manner, the auxiliary body remains hidden and protected behind the disc.

Preferably, the rotary electrical machine comprises a control device configured for controlling the energy conversion from mechanical to electrical, and preferably also vice versa.

The control device can be at least partly housed in the auxiliary body and/or in the brake caliper.

The control device is preferably configured for controlling the electrical machine as a generator and storing electrical energy. The electrical machine is therefore connected to an accumulator on board the vehicle.

Preferably, the control device is configured for controlling the electrical machine as a generator in the braking phases of the vehicle, in a manner so as to recover part of the kinetic energy that would otherwise be dissipated.

The control device can be configured for controlling the electrical machine as a generator during the running of the vehicle, absorbing however part of the drive power of the endothermic motor.

Preferably, the control device is configured for controlling the electrical machine as a motor and controlling an electromagnetic drive torque applied to the disc. It is for example possible to use the electromagnetic torque in brief time instances in order to integrate the power of the endothermic motor and/or to travel with zero emissions or to integrate the mechanical braking torque of the brake caliper.

The electrical energy accumulated in the accumulator can also be used for supplying power to a further, different electric motor operatively coupled to the drive shaft.

The braking system according to the invention can be implemented on at least one of the axle shafts of a vehicle, preferably on the two front axle shafts or on the two rear axle shafts, more preferably on all axle shafts.

Further characteristics and advantages will be clearer from the detailed description of a preferred but not exclusive embodiment of a method for increasing the performances of a tire for car wheels in accordance with the present invention.

### BRIEF DESCRIPTION OF THE DRAWINGS

Such description will be set forth hereinbelow with reference to the enclosed drawings, provided only as a non-limiting example, in which:

FIG. 1 shows a schematic view of a braking system according to the present invention;

FIG. 2 is a side view of the braking system of FIG. 1;

FIG. 3 illustrates a schematic view of an embodiment variant of the system of FIG. 1;

FIG. 4 is a side view of the braking system of FIG. 2;

FIGS. 5A and 5B illustrate respective views of a second variant of the braking system according to the present invention;

FIGS. 6A and 6B illustrate respective views of a third variant of the braking system according to the present invention;

FIGS. 7A and 7B illustrate respective views of a fourth variant of the braking system according to the present invention.

### DETAILED DESCRIPTION OF PREFERRED EMBODIMENTS OF THE INVENTION

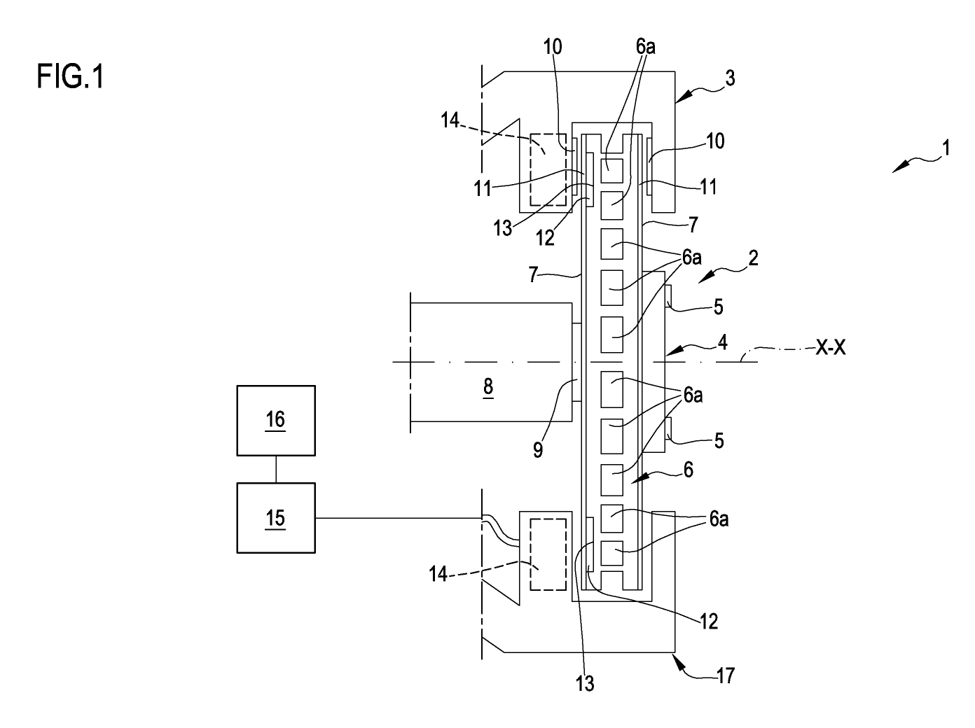

A braking system according to the present invention is indicated in its entirety in FIG. 1 with the reference number 1. The system 1 comprises a disc 2 of carbon-ceramic type and a caliper 3. The disc 2 comprises a drum 4, for example made of metal material, provided with attachments 5 for joining to the rim of a wheel of a vehicle. Around the drum 4 and integral therewith, a radially external band 6 is situated which constitutes the actual disc and is made of a ceramic matrix in silicon carbide reinforced with carbon fibers. The opposite surfaces of the radially external band 6 are covered with respective protective layers 7 made of ceramic material. The radially external band illustrated in the enclosed figures also has ventilation channels 6a made in the thickness of the band 6 itself which are extended along substantially radial directions and open at a radially peripheral edge of said band 6.

The radially external band 6 is for example obtained by means of the following steps:
preparing a mixture comprising at least filaments of carbon fibers and at least one organic binder;
forming, in a mold, the aforesaid mixture in order to obtain a shaped body;
pyrolyzing the shaped body in order to obtain a porous carbon structure;
infiltrating the carbon structure with silicon in order to obtain the aforesaid ceramic composite structure substantially with carbon, silicon and silicon carbide base;
depositing the protective coating on the opposite surfaces.

In an embodiment variant, the radially external band 6 is made of carbon fabric reinforced with carbon fibers.

The caliper 3 is placed astride the radially peripheral edge of the radially external band 6 and is integral with the frame of the vehicle or better yet with the fixed tubular body 8 which carries the rotary shaft 9 integral with the disc 2 and with the wheel. The caliper 3 comprises brake pads 10 facing respective braking surfaces 11 of the radially external band 6 and adapted to cooperate with the brake caliper 3 in order to exert a braking action on the vehicle.

The braking system 1 also comprises a rotary electrical machine at least partially integrated therein.

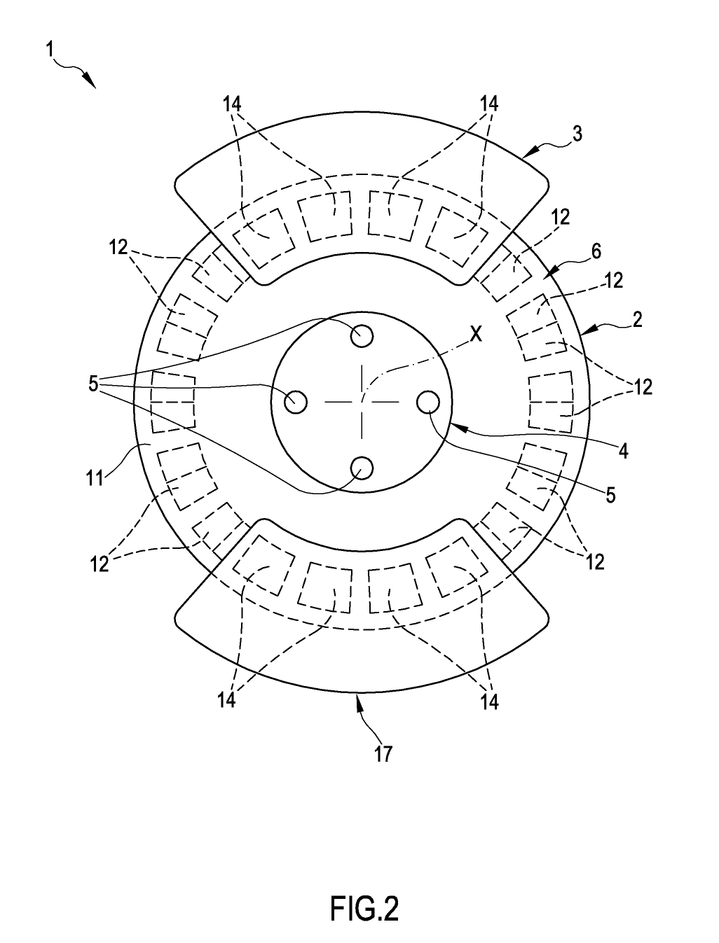

Said rotary electrical machine comprises a plurality of rotor elements 12 inserted in the radially external band 6 of the disc 2. In the embodiment illustrated in FIGS. 1 and 2, said rotor elements 12 are permanent magnets arranged along a circular path coaxial with the symmetry axis “X-X” of the disc 2 (rotation axis of the wheel) and inserted in slots 13 obtained in the composite material of the radially external band 6. The permanent magnets 12 lie flush with the respective surface of the radially external band 6 and are covered by the respective cover layer 7. The permanent magnets 12 are also radially situated at one of the braking surfaces 11. The slots 13 are for example shaped in the step of forming the aforesaid mixture in the mold and the permanent magnets 12 are subsequently inserted, before the application of the cover layer 7. Alternatively, the permanent magnets 12 can be inserted directly in the mold and themselves come to shape the slots 13 where they are housed.

The rotary electrical machine comprises a plurality of stator elements 14 electromagnetically coupled to the rotor elements 12. The stator elements 14, schematically represented in FIGS. 1 and 2, are induced windings and are electrically connected to a control device 15 of the machine itself and to an accumulator 16 (schematically illustrated in FIG. 1). In the embodiment of FIGS. 1 and 2, said stator elements 14 are installed in a portion of the brake caliper 3 and in an auxiliary body 17. The auxiliary body 17 is mounted astride the radially peripheral edge of the radially external band 6 and is integral with the frame of the vehicle or better yet with the fixed tubular body 8 that carries the rotary shaft 9 integral with the disc 2 and with the wheel. The auxiliary body 17 is installed on the disc 2 in a diametrically opposite position with respect to the brake caliper 3 (FIG. 2). In non-illustrated embodiment variants of the above-described form, said stator elements 14 are only installed in the brake caliper 3 or only in the auxiliary body 17.

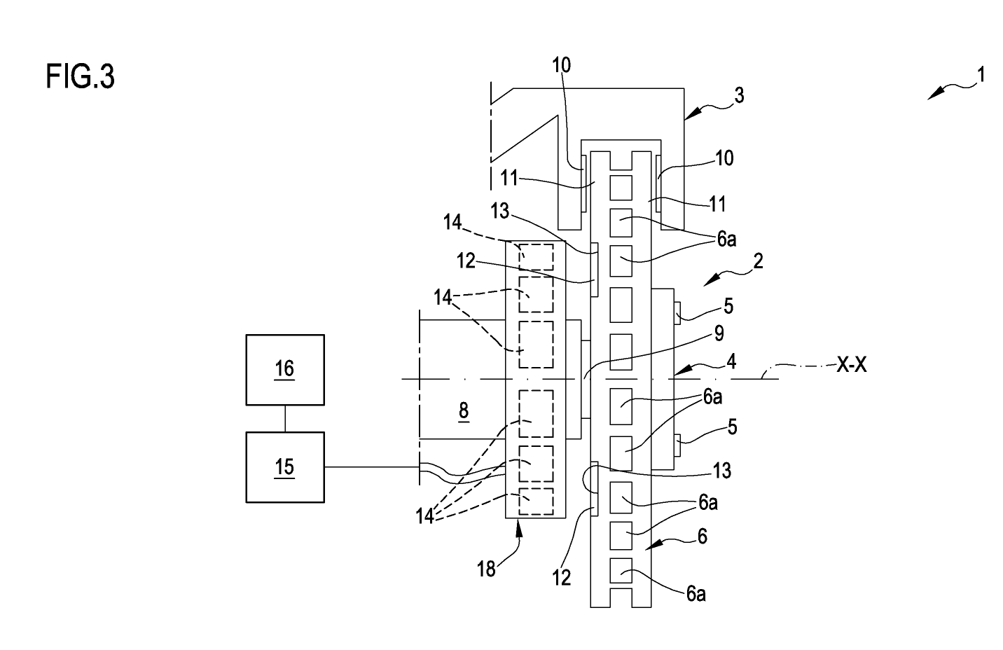

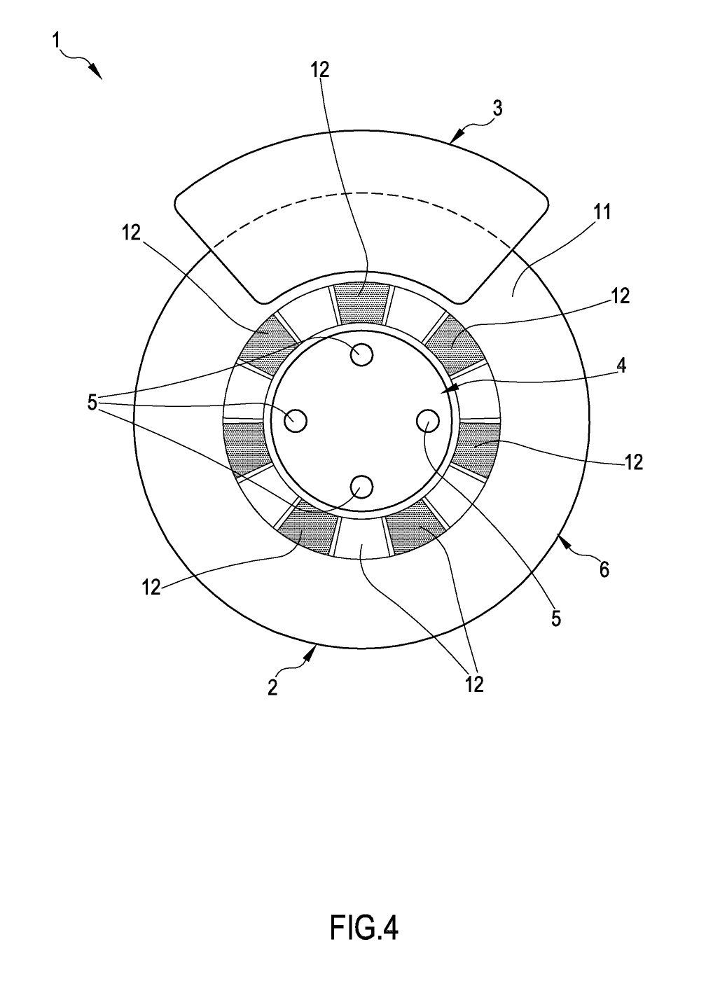

In the embodiment illustrated in FIGS. 3 and 4, the cover layers 7 (of the embodiment of FIGS. 1 and 2) are not present and the permanent magnets 12 are positioned at a radially internal zone with respect to the braking surfaces 11 on which the caliper 3 acts.

In addition, the stator elements 14 have a different placement. In particular, the stator elements 14 are mounted in an auxiliary body 18 fit on the fixed tubular body 8 which carries the rotary shaft 9 integral with the disc 2. The stator elements 14 are arranged around the symmetry axis “X-X” along a circular path and are axially facing the permanent magnets 12.

In other non-illustrated embodiments, the rotor elements 12 are situated in the ventilation channels 6a and/or in other parts of the radially external band 6, completely immersed/embedded in the composite material.

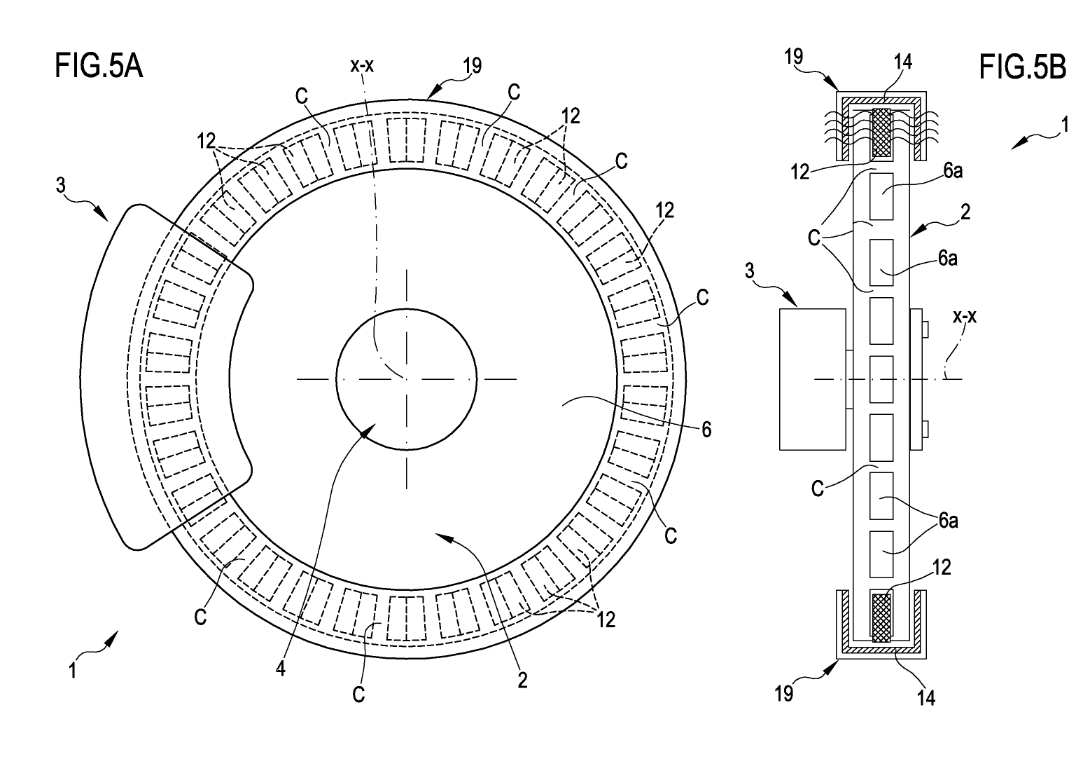

In a further embodiment, illustrated in FIG. 5A and in FIG. 5B, the disc 2 is made of metal material, preferably iron-carbon alloy, and the rotor elements 12 are permanent magnets housed in the ventilation channels 6a and at a radially peripheral portion of the disc 2 itself. The permanent magnets 12 are therefore arranged in series one after the other along a circumferential path. The walls of the ventilation channels 6a define parts made of conductive material “C” interposed between the rotor elements 12. The rotor elements 12 therefore define a periodic ferromagnetic structure with the parts made of conductive material “C” interposed with each other. The stator elements 14 (only illustrated in FIG. 5B) are constituted by U-shaped windings, arranged in series all around the disc 2. Each of the U-shaped stator elements is placed astride the radially peripheral edge of the disc 2 (FIG. 5B). The described stator elements 14 are partly housed in the brake caliper 3 and are supported thereby (for an arc of circumference corresponding to the extension of said caliper 3) and are partly housed in the auxiliary body 19 and are supported thereby. Such auxiliary body 19 is extended like a ring around the disc 2, except where the caliper 3 is present, and it too has a U-shape form in a radial plane. The electrical machine of such embodiment is an asynchronous axial machine where the interrupted magnetic flow has axial orientation, i.e. parallel to the rotation axis “X-X” of the disc 2. In a non-illustrated variant of the asynchronous axial machine, in place of the permanent magnets specific windings are present.

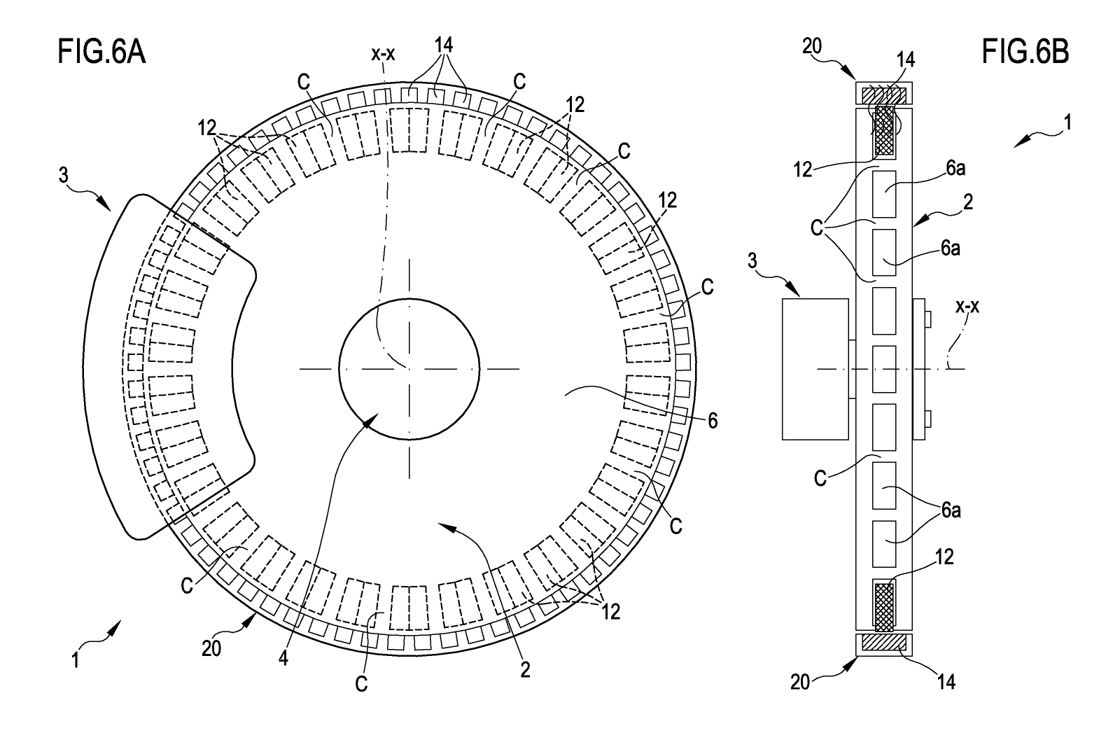

The further embodiment illustrated in FIG. 6A and in FIG. 6B is geometrically similar to the preceding one. Unlike the previous embodiment, the stator elements 14 are windings localized only circumferentially on the external diameter of the disc 2 where the interrupted magnetic flow has radial orientation. The auxiliary body 20 that supports the stator elements 14 is only placed in radially external position with respect to the disc 2 (it is not extended astride the disc 2) and is extended axially for a width corresponding substantially to the thickness of said disc 2.

FIGS. 6A and 6B represent both an asynchronous radial machine (in such case the stator elements 12 are constituted by specific windings) and a synchronous reluctance radial machine (in such case the stator elements 12 are constituted by permanent magnets).

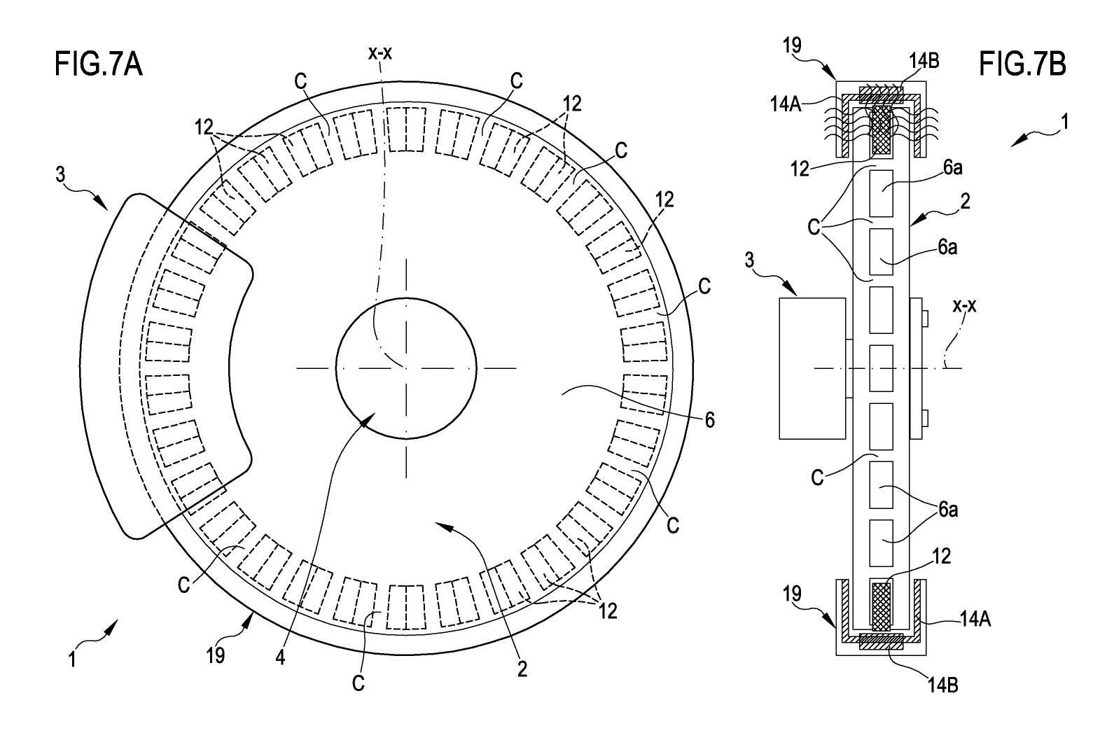

In the synchronous reluctance rotary machine, capable of a continuous movement, the auxiliary body 20 is constituted by or comprises a ferromagnetic cylindrical crown (stator) in which three windings 14 are situated with equivalent mutual spatial displacement and a three-phase alternating current system runs through them. This produces a rotating magnetic field whose effect is equivalent to that which is obtained by rotating the fixed part of the structure. If the disc assumes an angular velocity equal to that of the rotating magnetic field, the angle remains constant and the torque constant therewith, which supports the rotation thereof. The further embodiment illustrated in FIG. 7A and in FIG. 7B is a combination of the above-described types illustrated in FIGS. 5A, 5B, 6A, 6B, and it is an axial/radial hybrid machine. The auxiliary body 19 is similar to that illustrated in FIGS. 5A and 5B. Such auxiliary body 19 houses a first group of stator elements 14A with structure equivalent to or similar to that of the stator elements 14 illustrated in FIG. 5B and constituted by U-shaped windings arranged in series all around the disc 2. The same auxiliary body 19 also houses a second group of stator elements 14B with structure equivalent to or similar to that of the stator elements 14 illustrated in FIG. 6B and constituted by windings localized only circumferentially on the external diameter of the disc 2. The path of the flow is therefore transverse (both in axial and radial direction).

The described rotary electrical machine can function as a generator and/or as a motor.

In a preferred embodiment, the rotary electrical machine is a generator. The rotation of the wheels, of the brake discs 2 integral therewith and of the permanent magnets 12 generates a current in the windings of the stator elements 14. The mechanical energy transformed into electrical energy is stored in the accumulator 16.

It is preferable that such operation occurs in braking phase, i.e. when the endothermic motor does not apply a drive torque to the wheels. In such case, it is the energy associated with the braking torque exerted by the calipers that is transformed in electrical energy.

For such purpose, the control device 15 controls the conversion of energy in a manner so as to ensure that such recovery is possible.

It is in any case possible that the conversion also occurs when the vehicle is running with the motor that transmits torque to the wheels. In such condition, however, it is part of the power of the endothermic motor that is transformed into electrical energy.

In a preferred embodiment, the rotary electrical machine is also a motor. The electrical energy accumulated in the accumulator 16 supplies power to the stator elements 14 which induce an electromagnetic drive torque on the rotor, i.e. on the brake disc 2 and on the wheel associated therewith. Such electromagnetic drive torque can be used for integrating the torque of the endothermic motor in acceleration or the action of the calipers in braking.

In an alternative embodiment, the energy stored in the accumulator 16 can be transferred to the battery of a hybrid/electric vehicle, in a manner so as to increase the duration thereof, ensuring a greater kilometer distance run and/or greater power of the vehicle.

In a variant embodiment, the accumulated energy can be used for supplying power to a further and different electric motor operatively coupled to the motor shaft.

1. A disc for a disc brake of a vehicle, the disc comprising:
a drum and a radially external band that is extended around a symmetry axis (X-X), said radially external band having side braking surfaces adapted to cooperate with brake calipers in order to exert a braking action on a vehicle; and
rotor elements of a rotary electrical machine adapted to cooperate with stator elements of said rotary electrical machine mounted on the vehicle.

2. The disc according to claim 1, wherein said radially external band includes a composite material comprising carbon fibers.

3. The disc according to claim 1, wherein said radially external band includes a metal material.

4. The disc according to claim 1, wherein the rotor elements are associated with the radially external band.

5. The disc according to claim 2, wherein the rotor elements are embedded in the composite material.

6. The disc according to claim 2, wherein the rotor elements are inserted in housings in the composite material.

7. The disc according to claim 1, further comprising parts made of conductive material are between the rotor elements.

8. The disc according to claim 1, wherein the rotor elements are radially inward of the side braking surfaces.

9. The disc according to claim 2, wherein the rotor elements include surfaces covered by a protective layer which are adapted to contact with a pad of the brake caliper.

10. The disc according to claim 1, further comprising ventilation channels and the rotor elements are positioned in said ventilation channels.

11. The disc according to claim 1, wherein the rotor elements are permanent magnets.

12. A braking system comprising:
a disc configured to attach to and rotate with a wheel of a vehicle, wherein the disc includes rotor elements arranged in an annular band centered on a rotational axis of the wheel and an annular braking surface;
a brake caliper arranged astride the disc and aligned with the annular braking surface; and
a rotary electrical machine mounted to the vehicle and comprising stator elements aligned with the rotor elements on the disc.

13. The braking system according to claim 12, wherein the rotary electrical machine is an asynchronous axial machine.

14. The braking system according to claim 12, wherein the rotary electrical machine is an asynchronous radial machine.

15. The braking system according to claim 12, wherein the rotary electrical machine is a synchronous reluctance machine.

16. The braking system according to claim 12, wherein the rotary electrical machine is an axial/radial hybrid machine.

17. The braking system according to claim 12, wherein the stator elements are extended astride the disc.

18. The braking system according to claim 12, wherein the stator elements are only situated in radially external positions with respect to the rotor elements.

19. The braking system according to claim 12, wherein the stator elements are only situated in radially internal positions with respect to the rotor elements.

20. The braking system according to claim 12, wherein the stator elements are integrated into the brake caliper.

21. The braking system according to claim 12, further comprising an auxiliary body fixed with respect to the brake caliper, juxtaposed with the disc and comprising the stator elements.

22. The braking system according to claim 21, wherein the auxiliary body is a ring around a radially peripheral edge of the disc along a circumferential extension of said disc.

23. The braking system according to claim 21, wherein the auxiliary body is only placed in a radially external position with respect to the radially peripheral edge of the disc.

24. The braking system according to claim 20, wherein the auxiliary body is astride the radially peripheral edge of the disc.

25. The braking system according to claim 12, wherein the auxiliary body is positioned on the side opposite a connection of the disc to a wheel and facing the disc.

26. The braking system according to claim 20, wherein the auxiliary body is fitted on a tubular body carrying the shaft of the wheel.

27. The braking system according to claim 11, further comprising a control device configured to control the rotary electrical machine as a generator.

28. The braking system according to claim 27, wherein the control device is configured to control the rotary electrical machine as a motor applying an electromagnetic drive torque to the disc.

29. A braking system comprising:
a disc configured to attach to and rotate with a wheel of a vehicle about a rotational axis, wherein the disc includes a side braking surface in a plane perpendicular to the rotational axis and rotor elements arranged in an annular band centered on the rotational axis;
a brake caliper mounted to the vehicle and arranged astride the disc, wherein the brake caliper includes a brake pad configured to abut against the side braking surface;
a stator mounted to the vehicle and opposite to the rotor elements in a direction parallel to the rotational axis, wherein the stator and the rotor elements are inductively coupled together; and
a rotary electrical machine mounted to the vehicle and electrically connected to the stator element.

30. The braking system of claim 29 further ventilation channels within the disc and the rotor elements positioned in the ventilation channels.

31. The braking system of claim 29 further comprising an auxiliary body mounted to the vehicle and is astride the disc, wherein the auxiliary body includes elements of the stator.

32. The braking system of claim 29 wherein the rotor elements are arranged in an annular band which is aligned in a radial direction with the brake pad of the brake caliper.
